(19) United States
(12) Patent Application Publication
(10) Pub. No.: US 2019/0347625 A1
(43) Pub. Date: Nov. 14, 2019

(54) SYSTEM AND METHOD TO INCREASE LIQUIDITY COMBINING FIAT CURRENCY AND VIRTUAL CURRENCY IN A SALES TRANSACTION

(71) Applicant: Antoine Sorel Neron, Walnut, CA (US)

(72) Inventor: Antoine Sorel Neron, Walnut, CA (US)

(21) Appl. No.: 16/389,996

(22) Filed: Apr. 22, 2019

Related U.S. Application Data
(60) Provisional application No. 62/762,563, filed on May 8, 2018.

(51) Int. Cl. G06Q 20/06; G06Q 30/02

(52) U.S. Cl. CPC G06Q 20/065; G06Q 20/381; G06Q 30/0222; G06Q 30/0215

(57) ABSTRACT

A method and system for conducting a sales transaction between a seller and a buyer is provided. The method and system includes listing an item online for sale at a sale price in a client-server application system, instructing the client-server application system to conduct the transaction using dual currency, paying the sale price of the item using a first type of currency, and providing the seller or the buyer an amount in a second type of currency.

### FIELD

This application relates to a system and method for buyers and sellers of goods and services to reward each other with virtual currency for actions that have an economic benefit to either party in a sales transaction.

### BACKGROUND

In a sales transaction, a seller may place their item(s) on sale as they normally would during a sale and then the buyer pays the seller in one currency. However, this type of transaction is limited and economic value is also lost. For example, when a retailer puts something on sale for 30% off, they only receive the 70%. It would be desirable to provide a system and method in which buyers and sellers of goods and services in sales transactions reward each other for actions that can have an economic benefit to either party. It would also be desirable to have improvements for sales transaction systems and processes that solve a retail-specific problem of lack of liquidity.

### SUMMARY

In one aspect of the present invention, a computer-implemented method for conducting a sales transaction between a seller and a buyer is provided. The method includes listing an item online for sale at a sale price in a client-server application system, instructing the client-server application system to conduct the transaction using dual currency, paying the sale price of the item using a first type of currency, and providing the seller or the buyer an amount in a second type of currency.

In another aspect of the present invention provides, a sales transaction system for conducting a sale transaction online between a buyer and a seller is provided. The sales transaction system includes at least one memory configured for storing instructions and at least one processor coupled to the memory configured to execute the instructions to perform operations. The operations include listing an item online for sale at a certain price in a client-server application system, instructing the client-server application system to conduct the transaction using dual currency, paying the sale price of the item using a first type of currency, and providing the seller or the buyer an amount in a second type of currency.

### BRIEF DESCRIPTION OF THE DRAWINGS

FIG. 1 is a block diagram illustrating the general architecture of a client-server application system that operates in accordance with embodiments of the present invention;

FIG. 2 is a flow diagram of a method according to FIG. 1 in which a buyer rewards the seller within the system for purchasing one or more items; and

FIG. 3 is a flow diagram of a method according to FIG. 1 in which a bonus or rebate is used by the seller to reward the buyer within the system for purchasing one or more items.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices

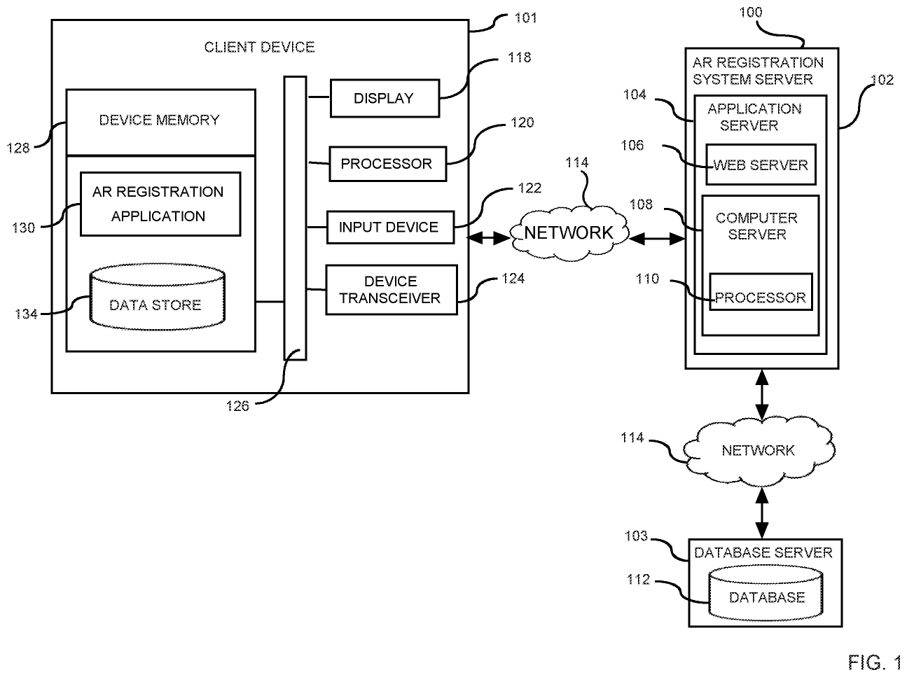

FIG. 1 illustrates the general architecture of a client-server application system 100 that operates in accordance with embodiments of the present invention. In a preferred embodiment, system 100 is implemented in multi-tier or n-tier architecture with one or more client devices 101 residing at the client tier, one or more servers 102 in the middle or server application tier and one or more database servers 103 residing in the database tier. In the above variant of three-tier architecture the client, the first tier, may have to only perform the user interface i.e., validate inputs; in which case the middle tier holds all the backend logic and does data processing while the data server, the third tier, performs data validation and controls the database access.

One or more client devices 101 are connected to system server 102 via a network 114. The system server 102 communicates with the client devices 101 over the network 114 to present a user interface or graphical user interface (GUI) for the service system 100 of the present invention. The user interface of the service system 100 of the present invention can be presented through a web browser or through a mobile application communicating with the system server 102 and is used for displaying, entering, publishing, and/or managing data required for the service. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 114 of FIG. 1 is for descriptive purposes only and it may be wired or wireless. Although the description may refer to terms commonly used in describing public networks such as the Internet, the description and concepts equally apply to other public and private computer networks, including systems having architectures dissimilar to that shown in FIG. 1. The inventive idea of the present invention is applicable for all existing cellular network topologies or respective communication standards, such as GSM, UMTS/HSPA, LTE and the like.

With respect to the present description, the system server 102 may include any service that relies on a database system that is accessible over a network, in which various elements of hardware and software of the database system may be shared by one or more users of the system 100. To this end, the users of the client device 101, from which a request or instruction is received over a network 114, may include any individual customer, a governmental or non-governmental organization, a group etc. The GUI or user interface provided by the system server 102 on the client devices 101 through a web browser or mobile app may be utilized by the users for utilizing service system 100.

The client device 101 is used by both buyers and sellers utilizing the present invention, and can be embodied, for example, in a smartphone.

The components appearing in system server 102 refer to an exemplary combination of those components that would need to be assembled to create the infrastructure to provide the tools and services contemplated by the present invention. As will be apparent to one skilled in the relevant art(s), all of components “inside” of system server 102 may be connected and may communicate via a wide or local area network (WAN or LAN).

The system server 102 includes an application server or executing unit 104. The application server or executing unit 104 comprises a web server 106 and a computer server 108 that serves as the application layer of the present invention. The Web server 106 is a system that sends out Web pages containing electronic data files in response to Hypertext Transfer Protocol (HTTP) requests from remote browsers (i.e. browsers installed in the client devices 101) or in response to similar requests made through a mobile app or mobile application of the present invention installed on a client device 101. The web server 106 can communicate with the mobile app of the present invention and/or with a web browser installed on a client device 101 to provide the user interface required for the service.

The computer server 108 may include a processor 110, a random-access memory (RAM) (not shown in figures) for temporary storage of information, and a read only memory (ROM) (not shown in figures) for permanent storage of information. Computer server 108 may be generally controlled and coordinated by operating system software. The operating system controls allocation of system resources and performs tasks such as processing, scheduling, memory management, networking, and I/O services, among (other) things. Thus, the operating system resides in system memory and, on being executed by CPU, coordinates the operation of the other elements of AR server 102.

Although the description of the computer server 108 may refer to terms commonly used in describing computer servers, the description and concepts equally apply to other processing systems, including systems having architectures dissimilar to that shown in FIG. 1.

The database tier is the source of data where at least one database server 103 generally interfaces multiple databases 112. Those databases are frequently updated by their users and administrators most often through a combination of private and public networks 114 including the Internet. It would be obvious to any person skilled in the art that, although described herein as the data being stored in a single database, different separate databases can also store the various data and files of multiple users.

A mobile application, or “app,” is a computer program that may be downloaded and installed in client device 101 using methods known in the art. Hereinafter, the mobile app 130 is referred to as app 130. App 130, custom built for the present invention, enables one or more persons to do various tasks related to live, in-person translation services using the system of the present invention. The activities related to the service of the present invention can also be performed using the user interface (or GUI) presented through a client device-based web browser. Hereinafter, the term “user interface” is used to refer to both app user interface and the web browser user interface of the present invention. Examples of client device 101 may include, but not limited to, mobile devices, tablets, hand-held or laptop devices, smart phones, personal digital assistants, desktop computers, wearable devices, augmented reality glasses, virtual reality headsets, or any similar device.

As illustrated in FIG. 1, the client device 101 may include various electronic components known in the art for this type of device. In this embodiment, the client device 101 may include a device display 118, a computer processor 120, a user input device 122 (e.g., touch screen, keyboard, microphone, and/or other form of input device known in the art), a device transceiver 124 for communication, a device memory 128, the AR app 130 operably installed in the computer memory 128, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

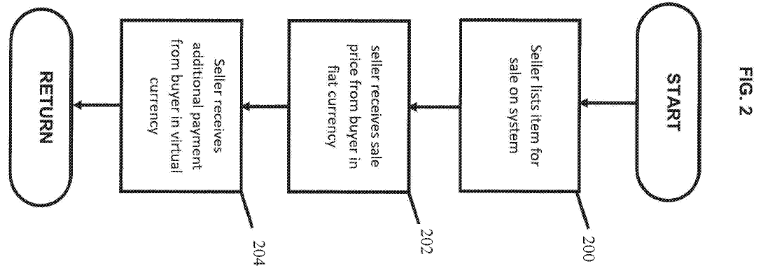

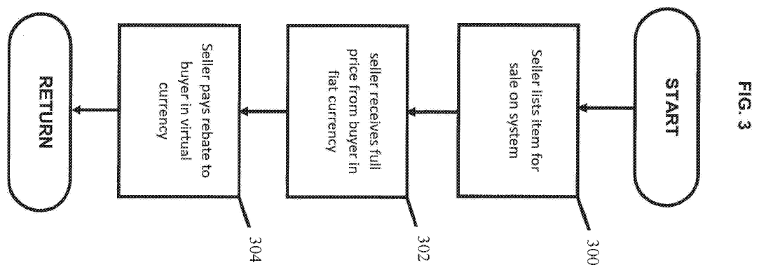

With reference now to FIGS. 2 and 3, an example methodology is illustrated and described. While the methodology is described as being a series of acts or steps that are performed in a sequence, it is to be understood that the methodology is not limited by the order of the sequence. For instance, some acts or steps may occur in a different order than what is described herein. In addition, a step may occur concurrently with another step. Furthermore, in some instances, not all steps may be required to implement a methodology described herein.

Moreover, the steps or acts described herein may be computer-executable instructions that can be implemented by the processor 120 or one or more processors and/or stored in the memory 128 and/or on a computer-readable medium or media. The computer-executable instructions may include a routine, a sub-routine, programs, a thread of execution, and/or the like. Still further, results of acts of the methodology may be stored in a computer-readable medium, displayed on a display device, and/or the like.

FIG. 2 shows an operative sequence of steps in which a buyer rewards the seller within the system for purchasing one or more items. The purchasing of the item may be made within the system or made outside of the system or both. The seller places their item(s) on sale as they normally would during their sales, then lists their item(s) on the system at step 200. The seller may list their item online and have an image of it displayed on the display device. The buyer may use a client device 101 to access the item via a graphical user interface through a web browser for example. The buyer may use a mouse and click on the item or other icon to purchase it. For example, the buyer may click on an icon next to the item that says “buy now”. After the user clicks on the icon, the buyer may then instruct the system to pay for the item by dual currency. The system may notify or prompt the user to confirm that this a transaction using dual currency. The buyer may indicate yes by clicking on an icon that says “yes” or use another way to confirm that a dual currency will be used in this transaction. The buyer—using the system to find the seller's listing—will pay the seller's sale price for the item in fiat currency (step 202), then reward the seller with digital or virtual currency for the difference between the sale price and regular price at step 204. The system sends the virtual currency to the seller when the fiat part of the transaction is confirmed. The amount of virtual currency required to purchase the item (along with fiat) is determined by the seller when they create an item listing. The system automatically transfers the virtual currency to the other party. The system then confirms payment and deducts virtual currency from a buyer's account in the system at the same time. In essence, for this sale listing (where a buyer rewards the seller for putting an item on sale), the system sends the virtual currency to the seller when the fiat part of the transaction is confirmed.

For example, if a store has a summer sale on a product that is regularly priced at $100 and would be $75 for the store sale, the store would set the reward percentage for their item in the system to 25%. Customers using the system would then pay the store's sale price of $75 in fiat currency directly to the seller, and $25 in virtual currency would be automatically credited to the store's account when the buyer approves the transaction in the system. It should be noted that other types of dual currency can be used.

FIG. 3 shows an operative sequence of steps in which a bonus or rebate is used by the seller to reward the buyer within the system for purchasing one or more items. The purchasing of the item may be made within the system or made outside of the system or both. For example, the system may provide a sale mechanism where a buyer rewards the seller for purchases made.

The seller places their item(s) for sale as they normally would during the sales, then lists their item(s) on the system at step 300. The buyer may use a client device 101 to access the item via a graphical user interface through a web browser for example. The buyer may use a mouse and click on the item or other icon to purchase it. For example, the buyer may click on an icon next to the item that says “buy now”. After the user clicks on the icon, the buyer may then instruct the system to pay for the item by dual currency. The system may notify or prompt the user to confirm that this a transaction using dual currency. The buyer may indicate yes by clicking on an icon that says “yes” or other way to confirm that a dual currency will be used in this transaction.

A buyer—using the system to find the seller's listing—will then pay the normal retail price of the seller's item in fiat currency step 302 and also receive a reward from the seller in digital or virtual currency at step 304. The system charges buyer the cost of the purchase and adds virtual or digital currency to buyer's account at the same time.

In essence, for a bonus listing (where a seller rewards the buyer for purchasing an item), the system sends the virtual currency to the buyer when the fiat part of the transaction is confirmed. The amount of virtual currency that the buyer will receive from the seller (once the item is paid for in fiat) is determined by the seller when they create an item listing. The system automatically transfers the virtual currency to the other party.

For example, if a store's product is regularly priced at $100 and the store lists the item in the system and sets the reward percentage for that item at 50%, customers will pay $100 in fiat currency directly to the store and $50 in virtual currency will be automatically credited to the buyer from the store's account once the store approves the transaction in the system.

While normal virtual currencies are meant to replace a fiat currency (that is, to be used in place of the US dollar, for example), this invention is for a transaction where the digital currency is used in tandem with fiat currency. The core of the invention is the dual currency nature of the transaction. Basically, any time fiat is exchanged from one party to another, virtual currency is also exchanged along with it.

The present invention provides economic value in a retail transaction that would normally be lost, and recycles that value back to the retailer via a secondary transaction initiated by the consumer. For example, when a retailer puts something on sale for 30% off, they only receive the 70%. However, with this method they'd get 70% in fiat currency and 30% in virtual currency.

The present invention provides a system for buyers and sellers of goods and services to reward each other with virtual currency for actions that have an economic benefit to either party, for example a sales transaction. The present invention also solves a retail-specific problem (of lack of liquidity), for which the solution is necessarily rooted in computer technology in order to overcome this problem by using virtual currency. The ‘Sale’ transaction allows consumers to reward the seller for placing an item on sale. In this way a seller can generate a supply of virtual currency to reward buyers in the next step of the process (Bonus) that generates cash flow for the business when buyers purchase items at the regular retail price. This process can, in theory, allow a business to profit from what a customer saved when they bought their product. Thus, it is possible for a seller to offer customers a discount of up to 99% in the sale transaction described in FIG. 2 and turn it into a profit or break-even in the bonus transaction described in FIG. 3. For example, if a seller sells software at a 100% profit margin, and receives $99 in digital currency for a software offered at 99% off, then offers another piece of software to other customers for $200 (with a $99 digital currency bonus), then such profits would be realized. The present invention is thus particularly advantageous for high margin items in a sales transaction. It should be noted that other types of currency (e.g. foreign currencies) or other combinations of currency can be used instead of the fiat and virtual currency. For example, the first and second types of currencies may be two types of virtual currencies. For example, someone may pay in bitcoin and receive another virtual currency as a bonus.

Although various embodiments of the disclosed system and method for buyers and sellers of goods and services to reward each other with virtual currency have been shown and described, modifications may occur to those skilled in the art upon reading the specification. The present application includes such modifications and is limited only by the scope of the claims.

What is claimed is:

1. A computer-implemented method for conducting a sales transaction between a seller and a buyer comprising the following operations performed by at least one processor:
listing an item online for sale at a sale price in a client-server application system;
instructing the client-server application system to conduct the transaction using dual currency;
paying the sale price of the item using a first type of currency; and
providing the seller or the buyer an amount in a second type of currency.

2. The computer-implemented method of claim 1, wherein the amount is provided to the seller, wherein the amount is the difference between the sale price and a regular price of the item.

3. The computer-implemented method of claim 1, wherein the first type of currency is fiat currency and the second type of currency is virtual currency.

4. The computer-implemented method of claim 1 further comprising sending the amount in the second type of currency to the seller after the item is paid using the first type of currency.

5. The computer-implemented method of claim 1 further including notifying the buyer to confirm that the sales transaction uses dual currency.

6. The computer-implemented method of claim 1, wherein the second type of currency is provided to the seller.

7. The computer-implemented method of claim 1, wherein the second type of currency is provided to the buyer.

8. A sales transaction system for conducting sales transaction online between a buyer and a seller comprising:
at least one memory configured for storing instructions;
at least one processor coupled to the memory configured to execute the instructions to perform operations comprising:
listing an item online for sale at a certain price in a client-server application system;
instructing the client-server application system to conduct the transaction using dual currency;
paying the sale price of the item using a first type of currency; and
providing the seller or the buyer an amount in a second type of currency.

9. The sales transaction system of claim 8, wherein the amount is provided to the seller, wherein the amount is the difference between the sale price and the regular price.

10. The sales transaction system of claim 8, wherein the first type of currency is fiat currency and the second type of currency is virtual currency.

11. The sales transaction system of claim 8, wherein the at least one processor is configured to execute the instructions to perform operations that include sending the amount in the second type of currency to the seller after the item is paid using the first type of currency.

12. The sales transaction system of claim 8, wherein the at least one processor is configured to execute the instructions to perform operations that include notifying the user to confirm that this a transaction using dual currency.

13. The sales transaction system of claim 8, wherein the second type of currency is provided to the seller.

14. The sales transaction system of claim 8, wherein the second type of currency is provided to the buyer.
